(19) United States
(12) Patent Application Publication
(10) Pub. No.: US 2021/0315767 A1
(43) Pub. Date: Oct. 14, 2021

(54) MODULAR ROLLER KIT COMPRISING A WALKING AID KNEE ROLLER WHICH IS CONFIGURABLE FOR AT LEAST TWO MEDICAL APPLICATIONS, AND METHOD FOR CONFIGURING THE KNEE ROLLER AND USE

(71) Applicant: CURVIN GMBH, SALZBURG, AIGEN (AT)

(72) Inventors: JULIAN SCHLAGHECK, MUENCHEN (DE); BORIS ANGELE, DIESSEN AM AMMERSEE (DE); MARC WOELFFER, SALZBURG (AT); DANILO SILVESTRIN, MUENCHEN (DE)

(73) Assignee: CURVIN GMBH, SALZBURG, AIGEN (AT)

(21) Appl. No.: 16/336,480

(22) PCT Filed: Sep. 26, 2017
(86) PCT No.: PCT/IB2017/001355

§ 371 Date: Mar. 26, 2019

(30) Foreign Application Priority Data
Sep. 27, 2016 (DE) 10 2016 118 180.3

(51) Int. Cl. A61H 3/04

(52) U.S. Cl. CPC A61H 3/04; A61H 2003/005; A61H 2003/046

(57) ABSTRACT

A wheeler kit includes a walking aid knee wheeler which supports a knee of a person having difficulty walking. The walking aid knee wheeler includes a chassis with a mounting interface and at least two wheel units which are pivotably mounted on the chassis in at least two axles. The wheeler kit further includes at least one module with a personal support which includes a knee support which is reversibly coupled in the mounting interface with the chassis, or at least one further module with a further personal support which includes a seat for at least one sitting position of the person. The at least one further module is reversibly coupled in the mounting interface with the chassis. The mounting interface is arranged further downward than a highest point of at least one of the at least two wheel units.

### CROSS REFERENCE TO PRIOR APPLICATIONS

This application is a U.S. National Phase application under 35 U.S.C. § 371 of International Application No. PCT/IB2017/001355, filed on Sep. 26, 2017 and which claims benefit to German Patent Application No. 10 2016 118 180.3, filed on Sep. 27, 2016. The International Application was published in German on Apr. 5, 2018 as WO 2018/060768 A1 under PCT Article 21(2).

### FIELD

The present invention relates to a wheeler kit comprising a walking aid knee wheeler especially for medical-technical appliances, a method for configuring the knee wheeler via a wheeler kit, especially for at least two different medical-technical appliances, respectively, as well as the use of a chassis of the walking aid knee wheeler.

### BACKGROUND

In some situations, persons disabled in walking or injured patients have to disburden a foot or a complete leg, especially due to foot operations and/or disorders within the region of a foot. A walking aid device can be used therefor, especially also a so called knee wheeler which may substitute crutches, at the very least temporary or in specific situations. Walking aid knee wheelers can be used e.g. in case of Achilles tendon disorders. Knee wheelers are available in diverse variants, e.g. foldable, and can be used simultaneously as support or crutches, or the wheelers are also provided with baskets for transporting any articles. Given that in any case, the persons disabled in walking and/or the patients feel uncomfortable on their own legs, most severe requirements as to robustness, stability and ergonomics should be imposed on such knee wheelers. Otherwise, any efforts of the patient for shortly becoming more mobile would be thwarted.

However, in many situations, such a knee wheeler is needed by the patient only for a short period, with the effect that the knee wheeler either is only lent, or that there is no considerable willingness to pay for its acquisition. As far as presently available knee wheelers are concerned, unfortunately, these knee wheelers tend to be rickety and not be of particular high quality, and that high-quality products attract less interest, with the effect that also the patient's recovery process does not proceed in a particularly optimal or effective or efficient manner. The patient does not identify with the knee wheeler, with the effect that the knee wheeler is not willingly used. The knee wheeler does not consist a product which may be willingly accepted by the patient. Rather, the patient takes the knee wheeler as a suggestion of personal disorders. However, one should counteract any proliferation of cheap articles which must be disposed after use, especially in order to increase acceptance for such evidentially constitutional knee wheelers.

US 2012/0161416 A1 describes a knee wheeler having a personal support with an elongated seat, which personal support is adjustable in height and is supported by two diagonal struts in a longitudinal guiding on a chassis of the knee wheeler. U.S. Pat. No. 7,111,856 B1 also describes a multifunctional device for supporting a person's knee or underarm or buttocks. US 2010/0007104 A1 describes a device for receiving an end of a thigh of an amputated leg.

### SUMMARY

An aspect of the present invention is to provide an in particular high-value robust walking aid knee wheeler which can be used in a plurality of situations. The knee wheeler is thereby in particular to be configured such that its configuration for any specific case of application can be carried out in straightforward manner, especially also manually by any untrained person. It is desirable to design a qualitatively and in particular high-value, long-lasting knee wheeler so that a broad spectrum of applications and long lifetime of the scooter or great applicability by its owner can be realized.

In an embodiment, the present invention provides a wheeler kit which includes a walking aid knee wheeler configured to support a knee of a person having a walking difficulty. The walking aid knee wheeler comprises a chassis comprising a mounting interface, and at least two wheel units pivotably mounted on the chassis in at least two axles. The wheeler kit further includes at least one module comprising a personal support which comprises a knee support which is configured to be reversibly coupled in the mounting interface with the chassis, or at least one further module comprising a further personal support which comprises a seat which is configured for at least one sitting position of the person having the walking difficulty. The at least one further module is configured to be reversibly coupled in the mounting interface with the chassis. The mounting interface is arranged further downward than a highest point of at least one of the at least two wheel units.

### BRIEF DESCRIPTION OF THE DRAWINGS

FIG. 1 shows a schematic illustration of an embodiment of a wheeler kit of the present invention;

FIG. 2 shows a schematic illustration of an embodiment of a wheeler kit of the present invention;

FIG. 3 shows a schematic illustration of an embodiment of a wheeler kit of the present invention;

FIG. 4 shows a schematic illustration of an embodiment of a wheeler kit of the present invention;

FIG. 5 shows a schematic illustration of an embodiment of a wheeler kit of the present invention;

FIG. 6 shows a schematic illustration of an embodiment of a wheeler kit of the present invention;

FIG. 7 shows a schematic illustration of an embodiment of a wheeler kit of the present invention;

FIG. 8 shows a schematic illustration of an embodiment of a wheeler kit of the present invention;

FIG. 9 shows a perspective view in schematic illustration a module in the form of a personal support with a knee support for a wheeler kit according to the embodiments;

FIG. 10 shows a schematic illustration of a first view of a chassis for a knee wheeler of a wheeler kit with diverse modules according to the embodiments;

FIG. 11 shows a schematic illustration of a second view of a chassis for a knee wheeler of a wheeler kit with diverse modules according to the embodiments;

FIG. 12 shows a schematic illustration of a third view of a chassis for a knee wheeler of a wheeler kit with diverse modules according to the embodiments;

FIG. 13 shows a schematic illustration of an embodiment of a wheeler kit of the present invention;

FIG. 14 shows a perspective view of a schematic illustration of a module in the form of a crutches receptacle for a wheeler kit according to the embodiments without crutches;

FIG. 15 shows a perspective view of a schematic illustration of a module in the form of a crutches receptacle for a wheeler kit according to the embodiments with crutches;

FIG. 16 shows a first perspective view of a schematic illustration of a wheeler kit according to the embodiments, with a module in the form of a personal support with the seat in an elevated position;

FIG. 17 shows a second perspective view of a schematic illustration of a wheeler kit according to the embodiments, with a module in the form of a personal support with the seat in an elevated position;

FIG. 18 shows a perspective view of a schematic illustration of a module in the form of a further personal support with an elevated seat for a wheeler kit according to the embodiments;

FIG. 19 shows a first perspective view of a schematic illustration of a wheeler kit according to the embodiments, with a module in the form of a personal support with the seat in a normal sitting position;

FIG. 20 shows a second perspective view of a schematic illustration of a wheeler kit according to the embodiments, with a module in the form of a personal support with the seat in a normal sitting position;

FIG. 21 shows a perspective view of a schematic illustration of a module in the form of an additional personal support with a seat for a wheeler kit according to the embodiments;

FIG. 22 shows a schematic illustration of an embodiment of a wheeler kit of the present invention;

FIG. 23 shows a schematic illustration of an embodiment of a wheeler kit of the present invention;

FIG. 24 shows a perspective view of a schematic illustration of a module in the form of a leg support for a wheeler kit according to the embodiments;

FIG. 25 shows a schematic illustration of an embodiment of a wheeler kit of the present invention;

FIG. 26 shows a perspective view of a schematic illustration of a module in the form of a drive unit for a wheeler kit according to the embodiments;

FIG. 27 shows a schematic illustration of an embodiment of a wheeler kit of the present invention;

FIG. 28 shows a schematic illustration of an embodiment of a wheeler kit of the present invention;

FIG. 29 shows a perspective view of a schematic illustration of a module in the form of a drive unit for a wheeler kit according to the embodiments;

FIG. 30 shows a perspective view of a schematic illustration of a module in the form of a drive unit for a wheeler kit according to the embodiments; and

FIG. 31 shows a perspective view of a schematic illustration of a module in the form of a drive unit for a wheeler kit according to the embodiments;

### DETAILED DESCRIPTION

The present invention provides a wheeler kit comprising a walking aid knee wheeler configured for supporting the knee and/or the (absolute) weight forces of a person disabled in walking due to foot disorders, the knee wheeler comprising a chassis and at least two wheel units pivoted on the chassis in at least two axles, especially in different longitudinal positions behind one another, wherein the wheeler kit comprises at least one module with a personal support with knee support which can be reversibly coupled in a mounting interface with the chassis, especially between the wheel units, wherein the wheeler kit comprises at least one further module with a further personal support with seat configured for at least one sitting position for a person disabled in walking due to knee or hip disorders which can be reversibly coupled, instead of the personal support, in the same mounting interface with the chassis, such that the knee wheeler is a multifunctional wheeler which is configurable also as seat scooter. The mounting interface can thereby be rigidly arranged in a mounting point with a predefined relative position on the chassis and/or the mounting interface can define the at least one mounting point, which allows for a backlash-free, solid connection. The mounting interface can thereby provide a or the single force transmitting point between the respective personal support and the chassis. The mounting interface can constitute the single, sole mounting interface between the respective personal support and the chassis.

In other words: the modular wheeler kit comprises at least two medical-technical modules having a medical-technical function, which may be used optionally. At least two medical-technical functions may thus be realized via the wheeler kit, namely, both supporting a knee and supporting buttocks or a hip after knee or hip operations. For persons being disabled in walking due to foot operations, especially Achilles tendon operations, a lower sitting position and also a different seat geometry is advisable than for persons which are disabled in walking due to knee or hip operations. Therefore, hitherto, these persons usually have been assisted by a specific walking aid respectively. It has now been found that via the modularity presently described, the same knee wheeler can be used for a plurality of medical-technical functions, without any trade-offs regarding ergonomics or physical recovery potential. The presently described wheeler kit can thus likewise be used in both situations. The knee wheeler can be used not only after foot operations, especially in case of Achilles tendon disorders, but also in case of hip or knee complaints. The range of applications can hereby be enlarged enormously, especially due to the high number of knee or hip operations within the last years and also in the future. Due to the mounting interface, the knee wheeler can also be configured as seat scooter in a straightforward manner. The personal supports can, for example, exhibit identical parts of mounting coupling. In the following, the terms “mounting interface” and “module mounting interface” are used as synonyms, since each mounting interface presently described serves for arranging at least one of the modules of the wheeler kit.

The wheeler kit can be configured as a modular-like multifunctional wheeler kit which can provide for individual modules for a respective function, e.g. a medical-technical seat module, a medical-technical leg support module, and/or a drive module. The modular-like concept allows for multiple appliances, so that it is reasonable to provide the knee wheeler in particularly high quality for a long product life cycle. With this knee wheeler, the patient thus obtains a product for being used in everyday life, and the patient may identify with the knee wheeler more easily or may notionally dissociate more easily from personal disorders. This may positively affect the recovery process.

The mounting interface can, for example, be accessible at the topside and/or at the underside. This allows the configuration (for a coupling process) to be changed in a straightforward manner. In particular, the mounting interface is arranged in a plane manner at a topside and/or at an underside of the chassis or is integrated in the chassis at the respective side. The respective personal support or the respective mounting coupling can, for example, exhibit at least one mounting plate which is mountable at the topside on the chassis and which is fixable at the topside and/or at the underside at the chassis. The process of coupling and/or configuring is hereby facilitated. In case the coupling process is carried out exclusively at the topside, the scooter is not required to be turned upside down. However, if has been found that carrying out the process of coupling (also) at the underside may provide good solidity/stability at the mounting interface. Optionally, additionally, also a process of laterally coupling at the side and/or at the front and/or at the rear can be carried out, especially in order to increase the stability in the mounting interface. Nonetheless, this is not necessarily required. It has been found that a process of coupling exclusively at the topside and/or at the underside may already provide for sufficient solidity, especially due to the arrangement of the mounting interface comparatively far down at or in the chassis.

As already described above, in addition to the knee support, the wheeler kit comprises at least one further module with a further personal support with a seat configured for supporting a person disabled in walking due to knee or hip disorders, such that the knee wheeler is also configurable as a seat scooter. The further personal support can thereby also comprise at least one seat strut configured for supporting a person disabled in walking and/or for supporting the person's (complete) weight at the person's buttocks in an elevated sitting position, especially two struts or a single strut being reinforced by a diagonal strut or by a plate.

It has been found that the knee wheeler also can be used as a walking aid, via an elevated seat and a particularly solid support strut, after hip or knee operations of diverse different types. This modular-like composition also in view of the seat or seat strut enlarges the medical-technical scope of application. The knee wheeler may still be used e.g. after an Achilles tendon rupture, but also in numerous other situations. The wheeler kit can further exhibit an additional (third) module with personal support which provides a further seat, e.g. having a wider geometry for use as pure seat scooter, especially in combination with a motor drive for the knee wheeler. Since each type of seat can be optimized for a specific function or for a specific vertical position, expediently, the respective personal support also respectively exhibits a specific support strut (especially optimized in view of stability or ergonomics). Optionally, however, a telescope-like support strut can also be provided which is compatible with at least two seats or knee supports. This reduces instrumental investments, for example, in the context with knee wheelers for kids causing rather moderate weights or elevation variations.

In an embodiment, the personal support and the further personal support can respectively comprise at least one part of a mounting coupling of the wheeler kit, which part is configured corresponding to the mounting interface, especially identical parts of the mounting coupling. This facilitates the coupling process. The part of the mounting coupling can in particular be provided by a lower free end of a support strut of the personal support.

In an embodiment, the mounting interface can, for example, be arranged further downward than a highest point of at least one of the wheel units, especially of a rear wheel unit, or further downward than a vertical position between at least one of the axles and a highest point of at least one of the wheel units. The personal support is accordingly also supportable in this lower vertical position at the chassis. This provides good stability, in particular with respect to the longitudinal axis (minimal tilting and/or rolling motion), and this also favors a use as a footbike/scooter (flat, freely accessible foot support). The personal support can thus be mountable and supportable at the chassis so that tilting torques or forces can be transferred to the chassis comparatively low in the height position of the axle(s) or even further downward than the axle(s).

The respective personal support can be supportable at the chassis in a vertical position between at least one of the axles of the wheel units, in particular between a rear wheel unit and a highest point of at least one of the wheel units, and/or below the (respective) axle.

In an embodiment, the respective personal support can, for example, be supportable in a vertical position between an axle of at least one of the wheel units, in particular a rear wheel unit and a highest point of at least one of the wheel units at the chassis, and/or below the (respective) axle. This also further provides good stability and favors the use of the knee wheeler also as scooter (footbike). A coupling of the personal support can thereby be arranged in a vertically integrated manner within the chassis.

The personal support can be supported in at least one point at the chassis, which is arranged, in vertical direction, at the very least approximately in the height of the axles or further downward than factor 3/2 of the height of the axles. This also further provides good stability and also favors the use as a scooter (footbike). Moreover, due to the low force transmitting points, only small tilting torques are generated. The scooter is bedded in a particularly steady manner, be it in its function as knee wheeler or as a scooter (footbike), or e.g. also as a seat scooter.

In an embodiment, the mounting interface can, for example, be arranged in a longitudinal position between both axles closer to a rear axle than to a front axle of said axles, in particular within a length section smaller ⅓ or ¼ of the distance between front and rear axles. This provides further variances for the multifunctional concept of the knee wheeler, in particular with respect to the accessibility to a foot support (be it for using the knee wheeler as a scooter (footbike), be it for transporting any objects on the foot support), or in particular while the mounting interface also allows for supporting a drive unit. Good support and stability can also be provided via the rear wheel unit. An ergonomic access to the personal support can also be realized.

In an embodiment, the chassis can, for example, substantially extend in a single plane in which the mounting interface is also arranged, in particular exclusively in a single plane between a/the front axle and the mounting interface, for example, in a plane xy which is aligned at the very least approximately horizontally. This provides further variances for the multifunctional concept of the knee wheeler. At the rear of the mounting interface, the chassis optionally also can slightly ascend upwards, in particular dependent on the type of implemented wheels, or in case the chassis can exhibit, for the purpose of better handling characteristics, in the rear direction a slight inclination downwards, in particular for a use as a scooter (footbike). Thereby, at the rear of the mounting interface, the chassis can also be configured with regard to a further or additional mounting interface for a drive unit, if required. For example, in the rear area, the geometry of longitudinal supports can be adapted, since in this area, any accessibility for a foot of the person is not required. However, apart from optional variations in the rear, the chassis can, for example, define a single plane. The single (xy-)plane does not thereby necessarily need to exhibit a (from a mathematical point of view) thickness converging to zero, it may rather also be referred to a range of e.g. 0.5 to 2 cm plane thickness, depending on the configuration of the chassis.

In an embodiment, the respective personal support or a mounting coupling of the personal support, correspondingly configured for the mounting interface, can, for example, exhibit at least one mounting plate. A mounting plate facilitates the supporting in a solid manner as well as the process of coupling. The mounting plate can, for example, be aligned in a horizontally aligned plane and/or in a longitudinal-cross-plane xy. It has been found that a mounting plate provides, in connection with the arrangement of the mounting interface on/in the chassis as herein described, both structural and also ergonomic advantages. The (respective) mounting plate e.g. exhibits a width of approximately 50 mm. The (respective) mounting plate e.g. exhibits a length of approximately 150 mm to 200 mm, in particular 175 mm. The mounting plate may also exhibit a rectangular geometry, having a length greater than the width. A mounting plate constituting the mounting interface on the chassis e.g. can be welded with/to one or several longitudinal supports of the chassis, or can be integrated therein or fixed thereto in a form- and/or force-fit manner.

In an embodiment, the mounting interface can, for example, be constituted by a mounting plate which is arranged at the chassis, in particular onto, on or between two longitudinal supports of the chassis, so that the respective personal support can be mounted frontally at the chassis (especially from the top in direction of gravity), especially in a plane defined by the chassis. This facilitates the supporting in a solid manner as well as the process of coupling. The mounting plate can be fixed in a mounting point defined by the longitudinal supports at the very least in a cross direction, without any risk of erroneous mounting. The longitudinal supports may define the mounting position. Great security can hereby be provided, even in case the knee wheeler is configured by a layperson, or in case of a new use as medical-technical knee or seat scooter after having been used as a scooter (footbike).

In an embodiment, the wheeler kit can, for example, comprise at least one mounting coupling configured for coupling the chassis and the personal support, via which the personal support is reversibly mountable in a form- and/or force-fit manner on the chassis, in particular at a topside of the chassis. The mounting process can, for example, be carried out at a topside or by access to a topside of the chassis, in particular rearward to the at least one standing position. According to a variant, the mounting coupling can be coupled manually, in particular in a tool-free manner, i.e., by an arbitrary person, without the need of using any tool.

The wheeler kit can further comprise a further (mounting) plate and/or dummy coupling, via which a mounting point for the personal support can be covered at the chassis in case the personal support is demounted from the chassis, in particular during use as a scooter (footbike). Even this part can be coupled manually.

The personal support can be supported at its underside and/or at the chassis at a mounting plate, which mounting plate exhibits at least two attachment points for different (length) positions of the personal support with respect to the chassis. The attachment points can be respectively configured for a form- and/or force-fit attachment mechanism, e.g. for a screw fitting, or for a kind of quick release. The personal support can be mountable at the chassis adjustably in a longitudinal direction and/or in a height direction, in particular while the personal support exhibits a telescope mechanism. The personal support can, for example, comprise a tube in tube-arrangement, for example, with at least one fit, in particular, a fitting sleeve made of POM material, for example, at a free end of an inner tube and/or of an internally bedded rod of the tube in tube-arrangement.

In an embodiment, the mounting interface can, for example, be constituted by a mounting plate which is arranged at the chassis, in particular between two longitudinal supports of the chassis, so that the respective personal support is mountable frontally at the chassis. This further facilitates both supporting in a solid manner and the process of coupling. A process of frontally mounting allows for transmitting gravitational forces directly to the chassis, without the need of transferring any torques.

The respective mounting coupling and/or the mounting interface can exhibit a slot aligned in longitudinal direction x. A slot allows for an adjustment of the longitudinal position in which the respective personal support should, for example, be arranged. One or several longitudinal supports of the chassis can thereby also provide a guiding for a mounting plate being slidable/adjustable between different longitudinal positions. A plate comprising a slot thus also provides advantages with regard to the adaptation of the knee wheeler for a respective patient.

In an embodiment, the chassis can, for example, exhibit two longitudinal supports which project in parallel to each other at the very least in sections in a cross distance y1, wherein the respective personal support or the respective mounting coupling exhibits at least one mounting plate which at the very least approximately is as broad as the cross distance y1. This allows the knee wheeler to be optimized both with regard to stability and also with regard to multifunctional applicability. A too broad chassis restrains the use as knee wheeler or as seat scooter, since the mobility of the healthy leg is then restricted. A too narrow chassis could become instable. When the mounting plate is provided to have, for example, a maximum broadness and uses to a full capacity the width of the chassis, the kind/manner of support can be optimized without any need to restrict the knee wheeler's functionality. The cross distance y1 can, for example, be approximately 45 mm to 55 mm, in particular 50 mm, with a distance of the center points of the longitudinal supports being e.g. approximately 80 mm. Given this width, two wheels of a rear wheel unit can still be mounted from the outside at the chassis and/or to the longitudinal supports.

In an embodiment, the chassis can, for example, exhibit at least one longitudinal support extending in a plane in predefined vertical coordinate which is configured to support a person's foot, in particular two longitudinal supports or a first and a second longitudinal tube, which project in parallel to each other at the very least in sections. This provides a particularly functional arrangement in which the chassis may fulfill a plurality of functions.

In an embodiment, the chassis can, for example, exhibit at least one longitudinal support extending in a plane in a predefined vertical coordinate, in particular a first and a second longitudinal tube which project in parallel to each other at the very least in sections. The longitudinal support can, for example, exhibit a plane at the very least in sections, in particular a topside or top edge aligned horizontally. The longitudinal tubes can be arranged in a distance in a cross direction y to each other which is smaller than the width of a plate of the mounting coupling. This favors supporting the mounting plate directly on the longitudinal tubes/supports.

In an embodiment, the knee wheeler can, for example, also be configurable as a scooter (footbike), while the module mounting interface is arranged, in particular in a vertical direction z at the very least partially vertically integrated within the chassis, so that with the personal support being mounted or demounted, at least one foot support which is arranged on the chassis or above the chassis is/remains kept free, which foot support defines at least one standing position for the person for using the knee wheeler as a scooter (footbike). A plane foot support bare of any hindrances can thereby be provided. The knee wheeler can optionally be used with or without a personal support. The foot support can thereby advantageously extend within the complete area and/or length section between the axles. The chassis can thereby be arranged and structured so that the knee wheeler is also configurable as a scooter (footbike) simply by demounting the respective personal support, without any further module. The foot support can thereby also be reversibly demountable and can constitute one of the modules. The foot support can, for example, be mounted in a fixed manner, i.e., in a manner which is compatible with the further functions of the knee wheeler. The mounting interface can, for example, be arranged rearward to a footstep position and/or standing position of the person on the chassis, i.e., behind it.

Advantageously, between a steering column of the knee wheeler and the mounting interface, the chassis provides an access area or a surface of predefined length accessible for a foot. The access area can be dimensioned so that, irrespective of the relative longitudinal position of the personal support on the chassis, space is provided for at least one foot between the mounting interface and the steering column.

In an embodiment, the chassis can, for example, be configured and arranged for supporting the person both in at least one knee position and also in the at least one standing/footstep position. This provides good stability and security irrespective of the kind of use. Good stability can in particular be provided by supporting the personal support in the mounting interface which is arranged further downward than a highest point or than the height extension of the wheel units, in particular at the very least approximately at/in the height of one of the axles. The knee wheeler can also exhibit a steering column, especially a steering column bedded at the chassis. The steering column can, for example, be constituted by a single (mono-)support strut. The scooter can, for example, exhibit only one single steering column. A handlebar of the steering column can, for example, be broader in cross direction than a rear axle and/or a rear drive shaft of the scooter. In cross direction, the handlebar can, for example, be broader than a footboard of the scooter. This favors ergonomic access, also for use as a scooter (footbike). A rear wheel unit of the scooter can, for example, be arranged centrally at the chassis with respect to the cross direction. A front axle or wheel unit of the scooter can, for example, thereby also comprise a steering axle. Each wheel unit can comprise e.g. two or more wheels arranged coaxially.

The steering column can exhibit an adjustment device comprising a folding mechanism, the adjustment device being laterally arranged on the steering column and being operable laterally from the right or the left. This allows for ergonomic access and free space in the region of a footboard and also for options with respect to the attachment of e.g. a crutches receptacle on the steering column, especially centrally in the front, and the adjustment device does not constrain the positions for the crutches receptacle. The adjustment device can also be configured as swivel joint. The steering column can be linked to a control arm or can comprise it, and on the control arm, joint bearings are arranged respectively for supporting a wheel of a front wheel unit, the joint bearings being aligned in the direction of the steering column, in particular in parallel to the steering column. The joint bearings can, for example, be supported in ball bearings.

In an embodiment, the knee wheeler can, for example, be a multifunctional wheeler configurable for at least one of the following further functions: a seat scooter for at least one sitting position in at least one vertical position for a person disabled in walking due to foot operations, in particular Achilles tendon operations, and/or a motor-driven seat scooter or a scooter (footbike), in particular configured for a maximum speed up to 6 km/h or 10-15 km/h. The wheeler kit can thereby comprise at least one further module with a further personal support with a (third) seat, in particular a particularly wide, ergonomic seat. At least one of the following components can be de-/mountable in a modular manner on the knee wheeler so that the knee wheeler is configurable for at least one, for example, two, for example, all three of the following further appliances: a seat scooter with the personal support configured for buttocks, in particular further comprising a leg support; a motor-driven scooter (footbike), in particular configured for a maximum speed up to 10-15 km/h; and/or a motor-driven seat scooter in particular with a leg support, in particular configured for a maximum speed up to 6 km/h. These appliances are additionally configurable for the use as knee wheeler with the personal support provided for a knee and for buttocks in an elevated sitting position, and additionally for the use as a pure scooter (footbike).

In an embodiment, between a/the front axle or front drive shaft and a/the rear axle or rear drive shaft of the wheel units, the chassis can, for example, define a supporting plane for a/the foot support and/or for a footboard, at the very least sectionally. This enlarges the functionality of the knee wheeler and enlarges the functions provided by the chassis. The supporting plane can define at least one surface for receiving weights of persons or loadings from above. Between a/the front and a/the rear axle, the chassis can be arranged in one single plane with a predefined vertical coordinate, at the very least sectionally. This allows for changing the function e.g. from a knee wheeler to a scooter (footbike) in a particularly straightforward manner. The chassis itself does not have to be modified therefor. The chassis can be completely rigid, with strictly predefined geometry. Not least, this also enhances the stability/robustness. The chassis can extend, at the very least sectionally, in a planar manner between a/the front and a/the rear axle on a level with the axles or in a plane extending between the axles, in particular completely between the axles. The axles and the chassis or a supporting plane defined by the chassis may all have the same vertical coordinate, at the very least approximately. In a cross-section, the supporting plane can constitute, together with a/the steering column of the knee wheeler and/or the personal support, individual sides of a parallelogram, projected on a longitudinal vertical plane xz. Between a/the front and a/the rear axle, the scooter or the chassis can exhibit a free length section which defines a lateral access clearance for a leg or a foot for reaching the personal support or a/the footboard. The scooter is hereby laterally accessible in a particular straightforward manner, in particular in a great clearance between front and rear axle, be it during use as a scooter (footbike), as a seat scooter or as a knee wheeler. The wheeler kit can exhibit at least one coupling via which the extension in a longitudinal direction of a lateral access clearance can be enlarged.

In an embodiment, the knee wheeler can, for example, also be configurable as a seat scooter for a person disabled in walking due to foot operations, while the personal support is configured and/or usable both as seat and also as knee support, wherein the personal support can, for example, respectively exhibit at least one curvature both for a knee and also for the person's buttocks. This also enlarges the functionality.

In an embodiment, the personal support can, for example, be swivel-mounted around the vertical axis z or around an axis defined by a support strut of the personal support and is fixable in at least two swivel positions, in particular in around two at the very least approximately 90° with respect to each other swiveled swivel positions, wherein the personal support can, for example, be configured for fulfilling at least three functions, in particular supporting the knee of the person in one or two of the swivel positions as well as constituting a seat for the person in at least one of the swivel positions.

In an embodiment, the knee support can, for example, exhibit a curvature in at least one spatial direction, in particular at least one curvature at a topside being concave downwards and inwards, for example, centrally on the topside. The at least one curvature enlarges the functionality, in particular with regard to a plurality of supporting positions, and provides ergonomic advantages. The knee support can exhibit, both in a longitudinal direction and also in a cross direction, at least one concave inward-curvature, in particular respectively centrally with respect to a topside of the knee support. This allows for a positioning of the knee from the side and from behind. The knee support can exhibit at least one wavelike edge, in particular both wavelike longitudinal edges and also wavelike cross edges. This enhances ergonomics and enlarges the functionality. At the rear, the knee support can be higher than in the front, and can in particular exhibit a protruding border. This provides good stability for the person, in particular in the form of a small back rest during use as a seat.

In an embodiment, the knee wheeler can, for example, also be configurable as a seat scooter for persons disabled at a leg, while the wheeler kit comprises at least one further medical-technical module comprising a leg support for supporting a shank of the person, which leg support is demountably supportable in a further module mounting interface at the chassis, in particular at a front cross support of the chassis. This also enlarges the knee wheeler's functionality. The leg support can, for example, be arranged laterally of a/the steering column of the knee wheeler. The leg support can be positioned/mountable via a spacer relative to the cross support on the cross support and/or on the chassis, in particular above a wheel of a front wheel unit of the wheel units. The leg support can exhibit at least one axle with at least one swivel mechanism for adjusting a relative position of a support for the leg.

In an embodiment, the leg support can, for example, exhibit a concave support for punctual and/or linear contact with the leg, which support is cylindrical at the very least in sections and/or is vaulted in a concave manner inwards circumferentially at the very least in sections. The leg support may thereby remain mounted in a fixed position, in particular on the chassis or on the steering column. Such a support provides advantages especially with respect to immobile or injured legs or feet which shall be laid down only temporary, in particular also with respect to persons of very old age. The leg support can optionally also exhibit a concave support for two-dimensional contact of a leg, which support is swivel-mounted around an axle being aligned at the very least approximately horizontally and can be fixed in at least two swivel positions. This favors the adaptation of the knee wheeler to a respective patient or to a respective (medical) application. The leg support may thereby remain mounted in a fixed position, in particular on the chassis or on the steering column. Such a support provides advantages in particular with respect to immobile or injured legs or feet which shall be laid down in a, for example, secure manner and for long journeys, in particular also with respect to legs with a cast or with respect to persons of very old age. The support of the leg support can be made of an elastic deformable, resilient material, in particular of soft foam. The respective concave curvature constitutes a bed for the leg and can prevent the leg slipping off from the support.

In an embodiment, the leg support can, for example, be positioned in cross direction y on the chassis and can be configured together with the chassis and/or with a mounting interface on the chassis in a symmetrical manner so that the leg support is mountable on both sides of a/the steering column of the knee wheeler (on the right/starboard and on the left/port). This allows for use of the leg support for each of both legs of a person disabled in walking. The leg support can also exhibit a swivel mechanism around a swivel axis of the support, which is configured for a swivel angle greater than 90°, for example, greater than 120°, namely, in both swivel directions. This allows for swiveling the support back and forth depending on whether the leg support is arranged on the portside or on the bow side of the steering column. According to one variant, the swivel axis corresponds to the forward, front axle or is arranged in the same position/orientation.

In an embodiment, the wheeler kit can, for example, comprise a footboard constituting the foot support, in particular a footboard being mountable at or on the chassis, which defines at least one standing position above the chassis for the person, wherein the module mounting interface is, for example, arranged below the footboard. In conjunction with further component parts, e.g. fixing means for the chassis, the footboard may constitute the foot support. A knee wheeler with footboard provides particularly numerous application possibilities, be it during rehabilitation or thereafter. It has been found that the knee wheeler may exhibit ergonomically preferable characteristics even in case a footboard is pre-mounted and also remains in the mounted state. The described arrangement of the mounting interface for the personal support favors the modular concept and/or the use as a scooter (footbike), and does not affect a scooter's user, rather, it can be arranged underneath the footboard and optionally can additionally be covered (e.g. at the very least partially by the footboard). The footboard may remain in the mounted state and can be used e.g. also as deposit surface for articles. The personal support can be arranged with respect to a steering column so that an access clearance for a standing/footstep position is definable therebetween. The knee wheeler can also be configurable as a scooter (footbike), while the footboard is mountable on the chassis in a retrofittable manner, or while it is already firmly pre-installed optionally. The footboard may directly rest on the chassis, in particular on a chassis being arranged/configured two-dimensionally in an upper plane. The footboard can likewise exhibit an underside which is completely planar. The footboard can define at least one footstep position and/or standing position for the person, in particular via a rough surface structure. The footboard may also overlap the module mounting interface for the personal support and/or a steering column of the knee wheeler in a longitudinal direction. The footboard can also exhibit a width which is bigger than the area and/or section of the chassis covered by the footboard. This provides ergonomic advantages in view of different types of application of the knee wheeler. A comparatively large-area foot support can also be provided so that the chassis or connecting elements or interfaces are covered and protected, or so that any injury risk is minimized for the patient. The footboard can exhibit, at the very least in sections, a rough surface structure configured for increasing the static and/or kinetic friction coefficient of the footboard's surface, in particular anti-slide-coatings arranged punctually or linearly. The surface structure can, for example, comprise at least one anti-slide-foil or at least one anti-slide-strip. This provides for good grip for a foot or also when using the footboard as loading floor. The rough surface structure can, for example, be integrated in a planar/flat manner in the footboard, or forms, at the most, minimum and/or maximum small embossments. The footboard can hereby exhibit a substantially planar/plane surface and can be used in versatile manner, e.g. also as deposit surface for loads. The footboard can be made of wood, of plastics or also of a metallic substance.

In an embodiment, the footboard can, for example, exhibit at least one recess, in particular a recess which is open in the rear, for a/the telescope mechanism of the personal support and/or a recess which is open in the front, for the steering column, wherein the recess is respectively arranged, for example, centrally with respect to the cross direction, wherein the recess preferably is configured geometrically corresponding to the module mounting interface for the personal support so that the module mounting interface is accessible at the topside. This allows advantage to be taken of the comparatively long length sections between the axles, irrespective of the longitudinal position in which the respective personal support should be mounted. The respective recess can, for example, be slot-like, which favors engagement with the steering column and/or the personal support. The rear recess in the footboard can thereby be designed to be at least as wide as the module mounting interface or a/the mounting plate for the personal support. This favors (de-)mounting. The footboard can be completely planar/plane. The footboard can extend from a/the front wheel unit as far as a/the rear wheel unit, in particular at the very least approximately from a/the front axle as far as a/the rear axle. This provides a comparatively great tread or load area and favors straightforward access for a foot to a footboard. Such dimensions of the footboard also allow a person to stand with both feet on the footboard.

In an embodiment, the wheeler kit can, for example, comprise at least one further medical-technical module comprising at least one crutches receptacle being reversibly de-/mountable on a/the steering column of the knee wheeler. This also allows for a broadening the knee wheeler's functionality optionally in a modular manner. The crutches receptacle module can be reversibly attached in a further mounting interface to the chassis and/or to the steering column, in particular in a relative position above an adjustment device of the steering column so that an interfolding/folding mechanism is not impeded. The crutches receptacle can exhibit at least one opening arranged in a lower section, in particular at an underside. This allows for drainage. The (respective) opening can be provided in a receptacle frame. The receptacle frame for the crutches can, for example, be arranged right down at the bottom at a lower end of the crutches receptacle. One or several recesses, in which walking sticks can be inserted, can also be arranged, for example, at a great distance with respect to the receptacle frame, in particular at the very top at an upper end of the crutches receptacle. This provides for good retaining function for crutches and good suitability for daily use, in particular with regard to insertion and extraction of crutches in a straightforward manner at the person's height position. The, for example, two opposing recesses are in particular arranged on a plate constituting the topside. The recesses can, for example, be configured geometrically corresponding to a rod of the respective crutches, i.e., as a notch having a semicircular ground. The corresponding mounting interface for the crutches receptacle can comprise at least one hub being at the very least partially circumferential and being provided for an attachment element of the crutches receptacle, in particular with an at the very least partially circumferential border for defining the vertical position of the crutches receptacle. The mounting interface can be arranged such that the crutches receptacle is mountable above an adjustment device of the steering column on the steering column. This allows for interfolding the scooter, without the need of demounting of the crutches receptacle. The crutches receptacle can be mountable frontally at a front side of the steering column, for example, via fastening clips framing the steering column. The fastening clips can be configured for static friction on the steering column. The fastening clips can, for example, be arranged rearward at the crutches receptacle. The crutches receptacle can further exhibit a coupling, in particular, a plug-in coupling for a luggage basket or an assimilable receptacle. This also enlarges modularity. The plug-in coupling can, for example, be accessible from above. This allows for suspending the luggage basket. The coupling can, for example, comprise a fixing device in at least two different vertical positions. This provides for good stability, even if the luggage basket is merely held by a comparatively free-moving plug connection. The plug-in coupling can be constituted by e.g. two or four clamps being open face up.

In an embodiment, the knee wheeler can, for example, also be configurable as motor-driven scooter, wherein the wheeler kit comprises at least one module comprising at least one drive unit, in particular with an electric motor, which drive unit is reversibly mountable and supportable at the chassis in the mounting interface or in a further mounting interface. This also enlarges the functionality of the knee wheeler, in particular by a very pragmatic usage/use of the chassis with regard to a plurality of functions. The wheeler kit can comprise at least one accumulator unit configured to supply energy to the drive unit. The wheeler kit can comprise at least one torque-proof driving shaft which can be coupled to at least one wheel of at least one of the wheel units.

In an embodiment, the wheeler kit can, for example, comprise a traction mechanism drive, in particular a chain drive, which is in functional connection with a motor of the drive unit. The wheeler kit can optionally comprise a static friction drive which engages at least one wheel of at least one of the wheel units, which in particular engages an outer tire or a wheel rim and which is in functional connection with a motor of the drive unit. The drive unit can optionally comprise a hub drive. The respective kind of the drive can be particularly advantageous depending on advised operating conditions of the scooter (speed, terrain, materials handling masses, etc.). The drive unit can be supported in one of the module mounting interfaces. The mounting interface for the personal support being arranged on the chassis is in particular configured so that at least two of these three drive units can optionally be coupled to the chassis and to at least one of the wheel units. This also enlarges the functionality, in particular by retrofitting the drive. The drive unit can comprise a rear motor which engages at least one and/or two wheels of a/the rear wheel unit. By using a torque-proof drive shaft, coupling the drive with only one of the wheels may suffice. The rear motor can be supported/supportable in at least one of the module mounting interfaces.

The knee wheeler can comprise at least one brake device in functional connection with at least one of the wheel units. The brake device can be manually operable, in particular by at least one brake handle at a/the steering column of the knee wheeler. The brake device can be in functional connection with at least one first wheel of a wheel unit arranged at the scooter's rear, wherein the first wheel is linked, for example, in a torque-proof manner, to a second wheel of the rear wheel unit, in particular by a torque-proof drive shaft. This provides the advantage that at least two wheels can be actuated by the (disk) brake, which provides a high degree of security for persons disabled in walking. The drive shaft can, for example, be mounted in ball bearings or in roller bearings. The brake device can in particular comprise at least one disk brake. A disk brake provides for good braking effect and is reliable. The brake device can also be adjusted in at least one predefined or predefinable braking state.

In an embodiment, the knee wheeler can, for example, be foldable, in particular at an interface or coupling between the chassis and a/the steering column of the knee wheeler. The knee wheeler can thereby exhibit a telescope-like steering column. In an embodiment, the knee wheeler can, for example, exhibit an adjustment device for a folding mechanism at a/the steering column, which is arranged in a vertical position further downward as ⅓ or ¼ of the height of the steering column in standard height for a person according to Norm, e.g. body size 180 cm, and which comprises an interfolding mechanism around a cross axis y. This vertical position allows for a particularly compact, folded configuration of the knee wheeler, in particular with demounted personal support. Since the mounting interface for the respective personal support is arranged comparatively low at the chassis, the adjustment device can likewise be arranged comparatively low, so that the knee wheeler can be interfolded in a very compact manner.

In an embodiment, a rear wheel unit of the knee wheeler can, for example, have a smaller width than a front wheel unit of the knee wheeler, wherein the width of the rear wheel unit is greater than ⅓ of the width of the front wheel unit. This allows for good stability in conjunction with good maneuverability. For example, in a cross direction, two wheels of the front wheel unit are in significantly greater distance to one another than two wheels of the rear wheel unit. This provides for high stability in the front and for good support of a person with respect to tilting torques, in particular without any restraint of the scooter's mobility or good maneuver characteristics.

In an embodiment, the rear wheel unit can, for example, comprise two wheels, in particular two wheels being linked via a torque-proof drive shaft. This allows for a quite solid bedding e.g. of a motor, and also for solidly supporting the personal support, in particular centrally between two wheels. The rear wheel unit can optionally exhibit only one single wheel, however, it has been found that two wheels arranged quite closely to one another (rear, coaxial pair of wheels) can significantly increase the scooter's stability and thus the security feeling for the patient. Nonetheless, the scooter can also be configured substantially as a tripod-scooter with a rear pair of wheels: comparatively broad in the front, and, for example, slim in the rear.

In an embodiment, the knee wheeler can, for example, comprises at least one brake device which is functionally connected with at least one of the wheel units, in particular a brake device with disk brake, which brake device engages a wheel of a wheel unit with two wheels being linked via a torque-proof drive shaft. This provides high security, in particular also during use of a drive unit for the knee wheeler. In an embodiment, the wheeler kit can, for example, comprise at least two module mounting interfaces for at least three modules, namely, for the medical-technical module with a knee support and for the medical-technical module with a seat, as well as for at least one further module out of the group: medical-technical leg support, medical-technical crutches receptacle, drive unit. Such a wheeler kit provides for a particularly broad functionality.

The present invention also provides a modular wheeler kit with a walking aid knee wheeler which is configurable, in addition to supporting a knee of a person disabled in walking due to foot operations, for at least one further function comprising a seat scooter-function for a person disabled in walking due to knee or hip disorders, in particular by a wheeler kit as described above, processed by providing at least two modules comprising at least one personal support with knee support and at least one further personal support with seat, respectively comprising a part of a mounting coupling, and by arranging at least one mounting interface, correspondingly configured for the respective part of the mounting coupling, for the respective personal support in a vertical position and/or longitudinal position on a chassis of the knee wheeler, such that the respective personal support is reversibly mountable, at the very least approximately, in the height of a standing position or behind the standing position on the chassis and is supportable in the height of the standing position or further downward on the chassis. This provides the advantages described above. The mounting interface can be arranged or configured on the chassis in a fully automated manner, be it in a reversible manner by form and/or force fit, be it irreversibly by positive substance jointing. The production process can be automated, for example, also inasmuch as a chassis, which has already been processed, can be retrofitted, while the mounting interface is attached to the chassis subsequently. The chassis can thereby be provided by designing at least two longitudinal supports extending in a plane between the mounting interface and a steering column, wherein the mounting interface can be fixed at the longitudinal supports. The longitudinal supports can thereby be arranged/arrangeable with respect to each other in a manner geometrically corresponding to the mounting interface. The knee wheeler can further be configurable for a scooter (footbike)-function, while the module mounting interface for the personal supports is arranged on the chassis so that at least one standing position or foot support of the knee wheeler is accessible or is kept free, the personal support being demounted or also being mounted.

The present invention also provides a method for configuring a knee wheeler via a wheeler kit, in particular by a wheeler kit as described above, for at least two medical-technical functions comprising the knee wheeler-function for a person disabled in walking due to foot operations and a seat scooter-function for a person disabled in walking due to knee or hip disorders, comprising the steps: providing at least two personal supports for the respective medical-technical function separate from the knee wheeler, respectively comprising a mounting coupling; providing the knee wheeler with a chassis comprising at least one mounting interface with a mounting coupling for coupling the respective personal support to the mounting interface; configuring as knee wheeler, while one of the personal supports is coupled to the mounting interface; or configuring as seat scooter, while the other personal support is coupled to the mounting interface. This allows for a flexible use for different medical-technical operation purposes. Such a method may also be applied, for example, in an automated manner, e.g. in a rehab hospital in which a comparatively great number of knee wheelers for diverse persons are configured. A configuration as a scooter (footbike) can optionally also be carried out, while the respective personal support is demounted and while with demounted personal support, at least one foot support supported or arranged at the chassis is kept free, which foot support defines at least one standing/footstep position for the person. At least one further coupling out of the following group can optionally be provided: (dummy) coupling for covering a module mounting interface for the personal support; mounting coupling for coupling a/the leg support; mounting coupling for coupling a/the drive unit; mounting coupling for coupling a crutches receptacle. The method then correspondingly can comprise one of the further steps: configuring the knee wheeler as seat scooter, while the personal support is in a sitting position adjusted, optionally also comprising the process of coupling or adjustment of a leg support; and/or configuring the knee wheeler as motor-driven scooter, while a drive unit is coupled to the chassis and to at least one of the wheel units. The configuration process can further respectively comprise a process of coupling the crutches receptacle.

In an embodiment, the configuration process can, for example, be carried out by coupling in the mounting interface further downward than a highest point at least one wheel unit of the walking aid knee wheeler or further downward than a vertical position between at least one axle of the walking aid knee wheeler and a highest point of the at least one wheel unit; or by coupling the respective personal support in a vertical position between at least one of the axles and a highest point of at least one of the wheel units to the chassis, or below the axle. This provides for advantages described above.

The present invention also provides the use of a mounting interface for reversibly coupling a respective module out of a group of at least two modules respectively with personal support to the chassis of the walking aid knee wheeler in a wheeler kit as described above. This provides for advantages described above.

The present invention also provides the use of a chassis of a walking aid knee wheeler as a mounting interface for reversibly coupling and supporting at least one, in particular at least two personal supports of a wheeler kit for a person disabled in walking due to knee or hip disorders and/or foot operations, respectively in a vertical position at the very least approximately corresponding to the vertical position of at least one axle of the knee wheeler or thereunder or in a height section overlapped by at least one wheel unit of the knee wheeler. This provides a solid arrangement irrespective of the configuration. The chassis can thereby also be used for attaching a foot support in the form of a footboard.

The use of the chassis for attaching a foot support in the form of a footboard can also be carried out, in particular in the vertical position as described above, and optionally also for attaching a leg support and/or for attaching a drive unit. The chassis can be used both for supporting the footboard and also for supporting the respective personal support, in particular in a same (horizontal) plane. The use of a (dummy) coupling on the chassis of the walking aid knee wheeler can thereby also be optionally carried out, for covering a mounting interface of a demounted personal support, in particular below a footboard of the knee wheeler, for configuring the knee wheeler as a scooter (footbike). The use of a coupling at the chassis for attaching a drive unit can thereby also be carried out, in particular in the mounting interface for the respective personal support and/or in a further module mounting interface in a rear area and/or at the rear end of the knee wheeler, in particular in a longitudinal position overlapping at the very least partially a rear wheel unit of the knee wheeler, for configuring the knee wheeler as a motor-driven scooter (footbike) or as a motor-driven seat scooter.

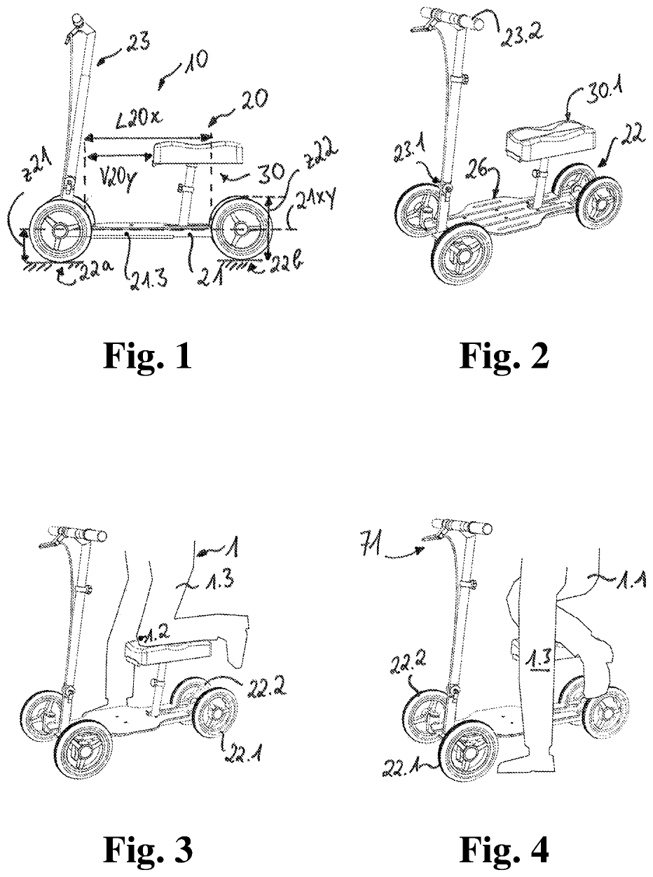

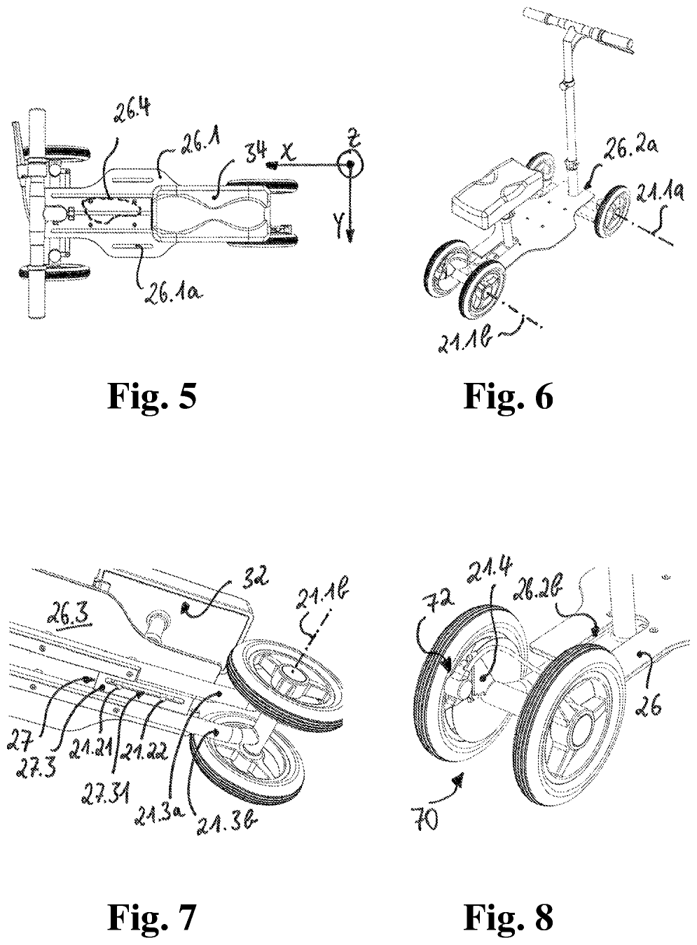

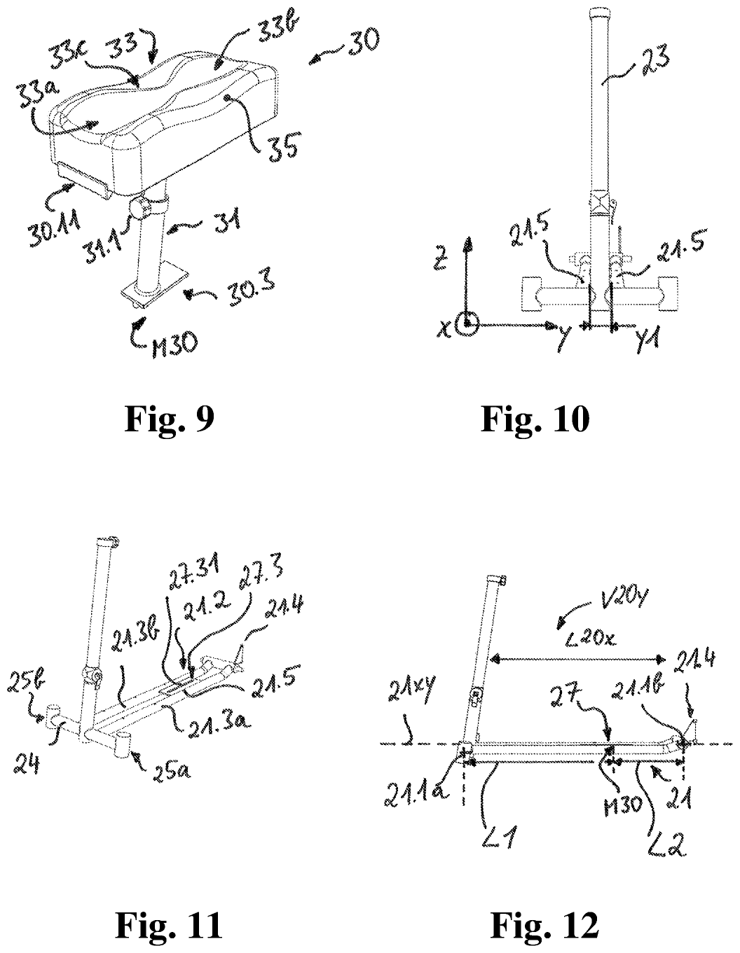

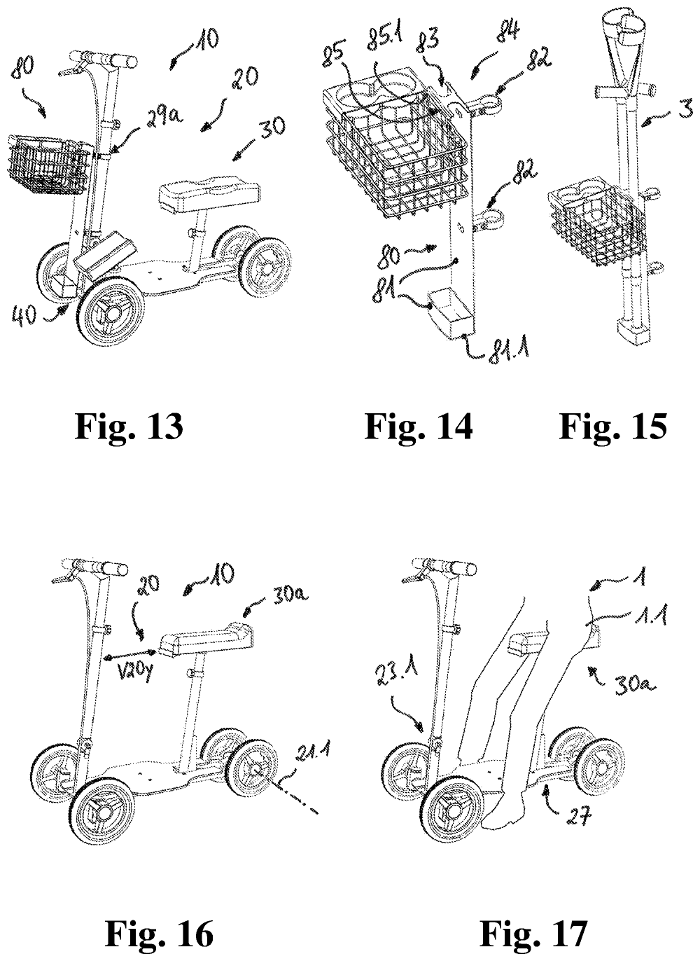

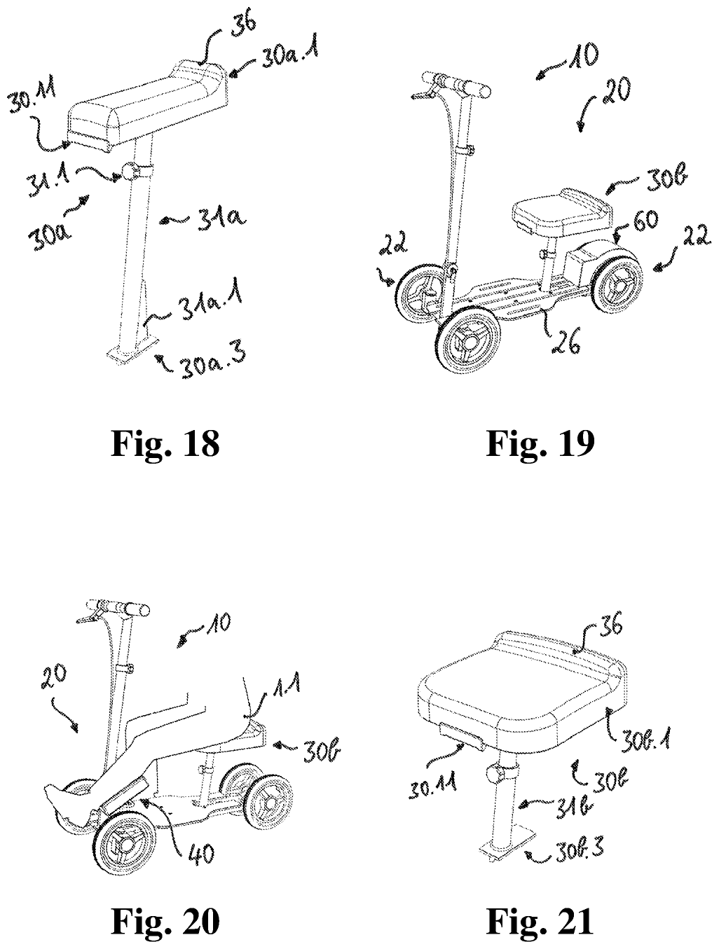

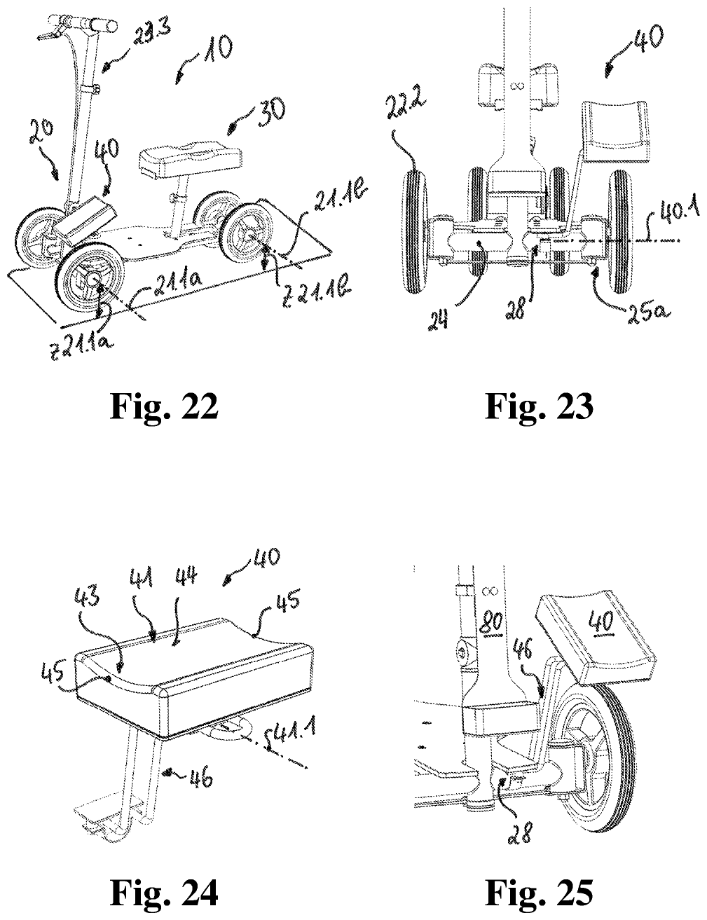

FIGS. 1-8, 13, 22-23, 25 and 28-28 show a wheeler kit 10 which comprises a multifunctional knee wheeler 20 with a footboard 26 in the form of a footboard and several modules which at least comprise a module in the form of a personal support 30 with a knee support 30.1 as well as at least one further personal support 30a, 30b with seat 30a.1, 30b.1. The wheeler kit 10 especially comprises at least the modules 30, 30a shown in FIG. 9 and FIG. 18. The knee wheeler exhibits a chassis 21 with two axles 21.1, wherein a front axle 21.1a and a rear axle 21.1b of a respective wheel unit 22 are pivoted on the chassis. The front wheel unit 22a and the rear wheel unit 22b respectively exhibit two wheels 22.1, 22.2. A handlebar 23.2 is attached to a steering column 23, wherein the steering column 23 can be folded by means of an adjustment device 23.1 and can be telescoped by a further adjustment device 23.3. A brake handle 71 of a brake device 70 with disk brake 72 is arranged at the handlebar 23.2 (FIGS. 4 and 8). The knee wheeler 20 further exhibits a front cross support 24 and two joint bearings 25a, 25b pivoted thereon, respectively for a wheel of the front wheel unit (FIG. 11). Further, a retaining element or lug 21.4 for fixing the brake, especially disk brake 72, is arranged at the chassis 21. Via a height adjustment device 31.1, the personal support 30, 30a, 30b being telescopable and/or adjustable in height with respect to the seat height or knee height can be coupled by a plate 30.3, 30a.3, 30b.3 to a corresponding plate of/to the chassis 21. In the front and at the rear, the footboard 26 respectively exhibits a recess 26.2a, 26.2b as well as a rough surface structure 26.1 with anti-slip-coating 26.1a. The recesses 26.2 allow for a solid arrangement of the footboard 26 between the steering column 23 and a support strut 31, 31a, 31b of the respective personal support 30, 30a, 30b. This configuration of the footboard 26 provides advantages especially also with respect to a function of the knee wheeler 20 as scooter (footbike). FIG. 13 shows a wheeler kit 10 with an additional module in the form of a crutches receptacle 80 which can be fixed in a further (fourth) mounting interface 29a at the steering column 23, in particular in a force-fitting manner by friction, wherein the mounting interface 29a is in particular provided by the outer lateral area of the steering column 23, or by an at the very least partially circumferential seat or by a mounting area around the steering column 23. The crutches receptacle 80 exhibits a receptacle frame 81 with at least one opening 81.1 (in particular a rainwater drain) as well as two fastening clips 82. One or several crutches 3 (FIG. 15) can be deposited in the receptacle frame 81. FIG. 14 shows two recesses 83 for accommodating these crutches, the recesses 83 being arranged at a topside 84 and/or at the upper free end of the crutches receptacle 80. By one or several couplings 85 respectively comprising a fixing device 85.1, in particular clamps, the crutches receptacle 80 can be (de-)mounted in straightforward manner at/from the steering column.

The respective personal support 30 exhibits a support strut 31 with a telescope mechanism, which is attached to the chassis 21 at an underside 32 of the knee support 30.1 and/or of the seat and in a mounting point M30 (FIG. 12) in a longitudinal distance L1 to the front axle 21.1a as well as in a longitudinal distance L2 to the rear axle 21.1b, wherein L1>L2, in particular L1>2×L2. This arrangement allows for good accessibility to a standing position 26.4. FIGS. 11 and 12 schematically elucidate the arrangement of the chassis 21 extending in a xy-plane (here: horizontal plane with longitudinal direction x and cross direction y) as well as of the mounting interface 27 for the personal support. The mounting point M30 is arranged in a free length section L20x of the chassis between both wheel units 22. A lateral access clearance V20y (for a foot) for reaching a footboard is thereby realized, which may extend, with the personal support 30, 30a, 30b being demounted, from the front wheel unit 22a as far as to the rear wheel unit 22b or at the very least as far as to a drive unit 60. The functionality is hereby enlarged. The chassis, especially a longitudinal support 21.3 or two longitudinal supports 21.3a, 21.3b thereof, thereby define a plane 21xy, in particular a supporting plane on which the footboard 26 is arranged and can be attached, in particular with its underside 26.3 in mounting points 21.5 and/or in bore holes. The axle 21.1a, 21.1b of the respective wheel unit 22 is arranged in a vertical position z21.1a, z21.1b (with respect to the vertical axis z) which presently corresponds to the vertical coordinate z21 (FIGS. 1 and 12), and on which the chassis 21 extends, and which is further downward than the highest height and/or than a highest point z22 of a respective wheel unit.

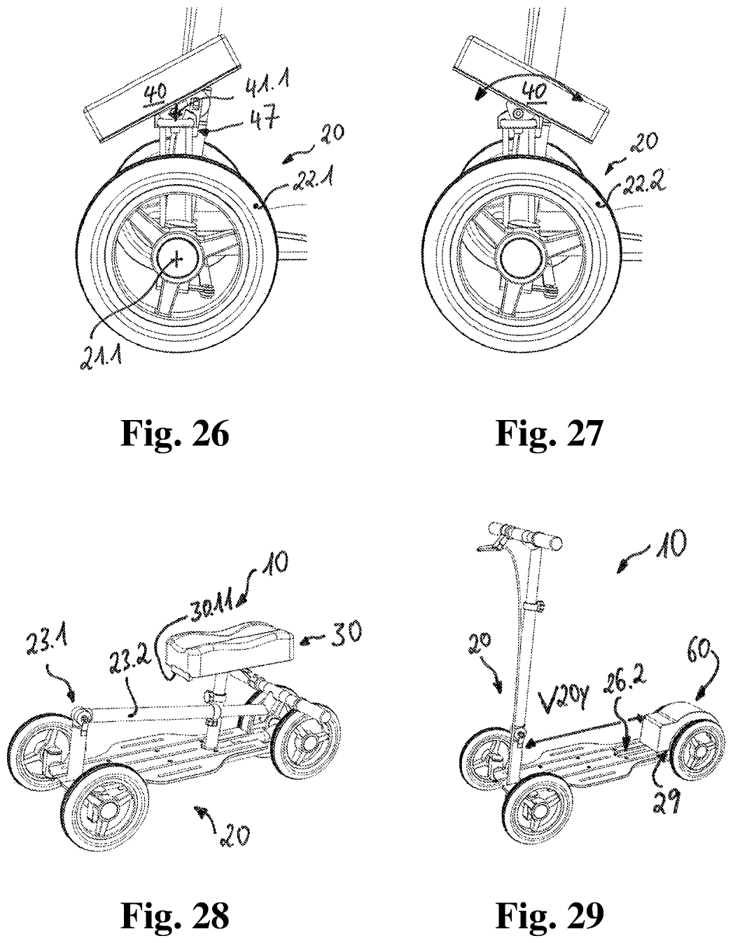

FIGS. 9, 18 and 21 show three respective variants for personal supports 30, 30a, 30b with a mounting coupling and/or a part of a coupling, in particular a mounting plate 30.3, 30a.3, 30b.3, which is arranged at a lower end of a support strut 31, 31a, 31b and which is configured geometrically corresponding with the mounting interface 27 and/or with the mounting plate 27.3. The mounting interface 27 thereby comprises a mounting plate 27.3 which is fixed in the mounting point M30 e.g. by positive substance jointing between both longitudinal supports 21.3a, 21.3b, and on which is provided a slot 27.31 extending in longitudinal direction x. The part 21.2 implied in FIG. 7 can comprise the mounting plate 27.3 or further components. The knee wheeler 20 can exhibit a part of a mounting coupling 21.2 with one or several attachment points 21.21, 21.22 (FIG. 7) which can be defined e.g. by indentations or grooves, wherein, for example, a screw fitting is respectively provided in the attachment points 21.21, 21.22, in particular with a screw nut which is screwed to the plate 27.3 from the bottom up. This allows for a secure resilient screw fitting and for good support via the chassis. The wheeler kit 10 can also comprise a (blind) plate and/or an adapter, which alternatively can be coupled to the mounting interface 27 when a personal support being demounted. FIG. 9 shows details of the knee support 30.1 being accessible both laterally and from behind for accommodating a knee 1.2 for a person 1 with buttocks 1.1, two knees 1.2 and two legs 1.3 (FIGS. 3 and 4). At a topside 34, a curvature 33 is provided in the seat 30.1 by concave inward-curvatures 33a, 33b, 33c, two thereof 33a, 33b being arranged centrally with respect to the cross direction y, and an inward-curvature 33c is arranged centrally with respect to the longitudinal direction x. The inward-curvatures 33a, 33b, 33c thereby consist a wavelike edge 35 which extends at the very least approximately circumferentially along the circumference of the seat. The knee support 30.1 and/or the respective seat 30a.1, 30b.1 exhibits a handhold 30.11 at the lower edge via which the knee wheeler 20 can be lifted, especially in a folded state (FIG. 28). The wheeler kit 10 can comprise one or several modules provided in the form of different leg supports 40. FIGS. 23-25 show details of a leg support 40 for linear or two-dimensional contact, which is adjustably supported at the chassis 21 cross support 24 by means of a spacer 46 in a torque proof manner around a tilting axis 40.1. The leg support 40 exhibits a support 41 with partially cylindrical concave curvature 43 being designed on its topside 44 and with concave edges 45. Additionally, the leg support 40 is also pivotable in different swivel positions around a swivel axis 41.1. The support 41 defines an axle, along which a leg can be supported in, for example, a solid and secure manner, wherein the support can be positioned in cross direction y by means of a cross adjustment 47, such that the support's 41 position can be adapted to the size of a person. FIGS. 26 and 27 show that the leg support 40 can be swiveled by a comparatively great angle greater than 45° up to greater than 90° around the swivel axis 41.1, namely, in both directions, for example, by at least 45°. This allows for mounting the same leg support 40 on the right or on the left with respect to the steering column, and further allows for swiveling the support 41 to the optimal resting position for the respective right or left leg 1.3.

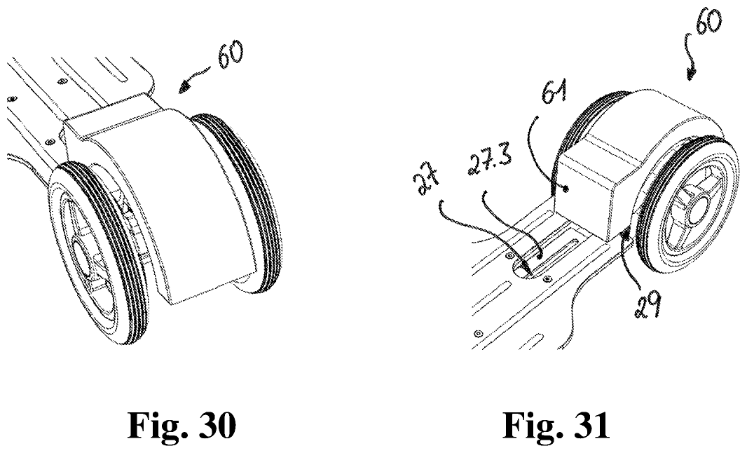

FIGS. 29-31 respectively show a wheeler kit 10 comprising a module in the form of a drive unit 60, especially with electric motor. Thereby, the drive unit 60 can be supported in a further (third) module mounting interface 29 which is arranged behind the mounting interface 27. Optionally, the drive unit 60 can also be supported in the mounting interface 27, additionally or exclusively, depending on the type of construction of the drive unit 60. According to an embodiment, the drive unit 60 comprises an accumulator unit 61 and a hub drive. Optionally, a traction mechanism drive, in particular a chain drive, with traction means can also be provided. The drive unit 60 can be coupled to the plate being arranged in the corresponding mounting interface. According to a further embodiment, the drive unit 60 can, for example, comprise a static friction drive with at least one pressing element engaging the respective wheel, in particular a roll made of material providing great frictional force. FIGS. 16-18 show a wheeler kit 10 with a personal support 30a with a support 30a.1 according to a further embodiment. This support 30a.1 is configured as seat 30a.1 for an elevated sitting position and provides a support for persons having knee or hip problems. A protruding border 36 prevents any backward slipping of the person and can constitute a kind of back rest. The corresponding support strut 31a is reinforced, especially at a lower end by a support plate 31a.1.

FIGS. 19-21 show a wheeler kit 10 with a personal support 30b with a seat 30b.1 according to a further embodiment. This seat 30b.1 is a wide seat and/or a large-area seat which is optimized with respect to comfort and ergonomics during sitting, and may provide an advantageous scooter for persons strongly disabled in walking or for notably old persons, especially in conjunction with a motor-driven chassis 21. A further (second) module mounting interface 28 provided for the leg support may in particular be provided by the outer lateral area of the cross support 24, or by an at the very least partially circumferential seat or a mounting area around the cross support 24 (FIG. 25).

The present invention is not limited to embodiments described herein; reference should be had to the appended claims.

What is claimed is:

1-15. (canceled)

16. A wheeler kit comprising:
a walking aid knee wheeler configured to support a knee of a person having a walking difficulty, the walking aid knee wheeler comprising,
a chassis comprising a mounting interface, and
and at least two wheel units pivotably mounted on the chassis in at least two axles; and
at least one module comprising a personal support which comprises a knee support which is configured to be reversibly coupled in the mounting interface with the chassis, or
at least one further module comprising a further personal support which comprises a seat which is configured for at least one sitting position of the person having the walking difficulty, the at least one further module being configured to be reversibly coupled in the mounting interface with the chassis,
wherein,
the mounting interface is arranged further downward than a highest point of at least one of the at least two wheel units.

17. The wheeler kit as recited in claim 16, wherein the mounting interface is arranged further downward than a vertical position between at least one of the at least two axles and the highest point of at least one of the at least two wheel units.

18. The wheeler kit as recited in claim 16, wherein the personal support is supportable in a vertical position,
between at least one of the at least two axles and the highest point of at least one of the at least two wheel units at the chassis, or
below the axle.

19. The wheeler kit as recited in claim 16, wherein,
the at least two axels comprises a front axle and a rear axle, and
the mounting interface is arranged between the at least two axles, but closer to the rear axle than to the front axle.

20. The wheeler kit as recited in claim 19, wherein the mounting interface is arranged within a length which is less than ⅓ or ¼ of a distance between the front axle and the rear axle.

21. The wheeler kit as recited in claim 19, wherein the chassis is configured to extend in a single plane in which the mounting interface is also arranged.

22. The wheeler kit as recited in claim 21, wherein the chassis is configured to extend exclusively in a single plane between the front axle and the mounting interface.

23. The wheeler kit as recited in claim 16, wherein,
at least one of the personal support and the further personal support comprises a mounting coupling, and
the personal support, the further personal support, or the mounting coupling of the personal support or the further personal support comprises at least one mounting plate which is configured for the mounting interface of the chassis,
or,
the mounting interface is provided by a mounting plate which is arranged at the chassis so that the personal support or the further personal support is mountable frontally at the chassis.

24. The wheeler kit as recited in claim 19, further comprising:
at least one foot support arranged on the chassis or above the chassis, the at least one foot support defining at least one standing position for the person,
wherein,
the walking aid knee wheeler is further configured as a scooter (footbike), and
the mounting interface is arranged to be in part vertically integrated within the chassis so that the foot support is free when the personal support or the further personal support is mounted or demounted.

25. The wheeler kit as recited in claim 24, wherein the chassis is configured to define a supporting plane for the foot support between the front axle and the rear axle at least in sections.

26. The wheeler kit as recited in claim 24, wherein,
the chassis further comprises at least one longitudinal support which is configured to extend in a horizontal plane and to support a foot of the person, or
the chassis further comprises two longitudinal supports, each of which are configured to project in parallel to each other, at least in sections.

27. The wheeler kit as recited in claim 16, wherein,
the personal support comprises a support strut,
the walking aid knee wheeler is further configured as a seat scooter for the person, and
the knee support is further configured as a seat, or
the knee support is swivel-mounted around a vertical axis or is swivel-mounted around an axis defined by the support strut so as to be fixable in at least two swivel positions.

28. The wheeler kit as recited in claim 16,
wherein,
the walking aid knee wheeler is further configured as a seat scooter for the person,
the chassis further comprises a further mounting interface, and
the wheeler kit further comprises:
at least one medical-technical module comprising a leg support which is configured to support a shank of the person, the leg support being demountably supportable in the further mounting interface at the chassis,
or,
wherein,
the chassis further comprises a further mounting interface, and
the walking aid knee wheeler is further configured as a motor-driven scooter, and
the wheeler kit further comprises:
at least one module comprising at least one drive unit, the at least one drive unit being reversibly mountable and supportable at the chassis in the mounting interface or in the further mounting interface.

29. The wheeler kit as recited in claim 16, further comprising:
at least three modules comprising,
a medical-technical module comprising the knee support,
a medical-technical module comprising a seat, and
a medical-technical leg support, a medical-technical crutches receptacle, or a drive unit; and
at least two mounting interfaces for the at least three modules.

30. The wheeler kit as recited in claim 16, wherein,
each of the at least two wheel units comprise two wheels, and
further comprising:
a torque-proof drive shaft which is configured to link the two wheels of at least one of the at least two wheel units; and
at least one brake device which is functionally connected with at least one of the at least two wheel units, the at least one brake device being configured to engage one wheel of one of the at least two wheel units.

31. The wheeler kit as recited in claim 30, wherein the at least one brake device is a brake device with a disk brake, the brake device being configured to engage with the one wheel of one of the at least two wheel units.

32. A modular wheeler kit comprising:
a walking aid knee wheeler which is configurable to support a knee of a person having a walking difficulty and for at least one further medical-technical function comprising a seat scooter-function for the person; and
at least two modules comprising,
at least one personal support comprising a knee support and a part of a mounting coupling,
at least one further personal support comprising a seat and a part of a mounting coupling, and
at least one mounting interface which is configured for the respective mounting coupling,
wherein,
the at least one mounting interface is arranged so that the respective personal support is reversibly mountable in a height of a standing position or behind the standing position on the chassis and is supportable in the height of the standing position or further downward on the chassis, and
the mounting interface is arranged further downward than a highest point of at least one wheel unit of the walking aid knee wheeler.

33. A method for configuring a walking aid knee wheeler via a wheeler kit for at least two medical-technical functions comprising a knee wheeler-function and a seat scooter-function, the method comprising:
providing at least two personal supports for the at least two respective medical-technical functions which are separate from the walking aid knee wheeler, each of the at least two personal supports comprising a part of a mounting coupling;
providing the walking aid knee wheeler with at least one wheel unit and a chassis, the chassis comprising at least one mounting interface which is correspondingly configured for the part of the mounting coupling, the at least one mounting interface being arranged further downward than a highest point of the at least one wheel unit; and
coupling one of the at least two personal supports to the mounting interface so as to provide a configuration as a knee wheeler, or
coupling another of the at least two personal supports to the mounting interface so as to provide a configuration as a seat scooter, or
demounting each of the at least two personal supports, while keeping free at least one foot support supported on the chassis, the at least one foot support defining at least one standing position for the person, so as to provide a configuration as a scooter (footbike).

34. The method as recited in claim 33, wherein,
the walking aid knee wheeler further comprises at least one axle, and
the configuration is performed via a coupling in of the mounting interface further downward than a highest point of the at least one wheel unit of the walking aid knee wheeler or further downward than a vertical position between the at least one axle and the highest point of the at least one wheel unit;

35. The method as recited in claim 33, wherein,
the walking aid knee wheeler further comprises at least one axle, and
the configuration is performed via a coupling in of the at least two personal supports in a vertical position between the at least one axle and a highest point of the at least one wheel unit to the chassis, or below the at least one axle.

36. A method of using a mounting interface to reversibly couple a module selected from a group of at least two modules, the module comprising a personal support, to a walking aid knee wheeler, the method comprising:
providing the walking aid knee wheeler of the wheeler kit as recited in claim 16;
providing the module; and
coupling the module to the chassis of the walking aid knee wheeler via the mounting interface.

37. A method of using a chassis of a walking aid knee wheeler as a mounting interface to reversibly couple and support at least one personal support, the method comprising:
providing the walking aid knee wheeler of the wheeler kit as recited in claim 16;
providing the at least one personal support; and
reversibly coupling and supporting the at least one personal support to the chassis of the walking aid knee wheeler as the mounting interface,
wherein,
the coupling and supporting is arranged in a vertical position corresponding to a vertical position of at least one of the at least two axles of the walking aid knee wheeler or thereunder or in a height section which is overlapped by at least one of the at least two wheel units of the walking aid knee wheeler.
